(19) United States
(12) Patent Application Publication
(10) Pub. No.: US 2007/0187450 A1
(43) Pub. Date: Aug. 16, 2007

(54) Pliers type stapler

(76) Inventor: Chun-Yuan Chang, Taichung (TW)

Correspondence Address: Charles E. Baxley, ESQ., 90 John Street - Suite 309, New York, NY, 10038, US

(21) Appl. No.: 11/353,213

(22) Filed: Feb. 14, 2006

(51) Int. Cl. B25C 5/00

(52) U.S. Cl. 227/129

(57) ABSTRACT

A pliers type stapler includes a case assembly, a magazine, a trigger mechanism, and a push mechanism. The case assembly includes a first handle, a metallic plate, a striking plate, and a second handle. The trigger mechanism includes a pivot member, and a torsion spring. Thus, the striking plate is lowered from its uppermost position to staple the article to be stapled instantaneously so that the striking plate has greater impact stroke and strength to staple the article efficiently without incurring deflection, thereby enhancing the stapling effect and quality of the stapler. In addition, the stapler is operated like pliers, so that the user can operate the stapler conveniently, thereby saving the manual work.

### BACKGROUND OF THE INVENTION

1. Field of the Invention

The present invention relates to a stapler and, more particularly, to a pliers type stapler.

2. Description of the Related Art

A conventional stapler comprises a base, an anvil mounted on the base, a case assembly pivotally mounted on the base by a hinge pin, a magazine and tie plate assembly pivotally mounted between the base and the case assembly and having a rail, a plurality of staples contained in the rail of the magazine and tie plate assembly, a follow block mounted in the rail of the magazine and tie plate assembly to block and push the staples, and a follow spring mounted between the case assembly and the follow block to drive the follow block. When the case assembly is pressed toward the base by a user, one of the staples is pressed toward the anvil to staple an article to be stapled, thereby accomplishing the stapling function.

However, the distance between the case assembly and the staples is very short, so that the force applied on the staples by the case assembly is limited, thereby decreasing the stapling effect of the stapler. In addition, the stapler has a complicated construction, thereby greatly increasing the costs of fabrication. Further, the stapler is not assembled easily and rapidly, thereby causing inconvenience in assembly of the stapler. Further, the staples are not placed into the magazine and tie plate assembly easily and rapidly, thereby causing inconvenience to the user when feeding the staples.

### SUMMARY OF THE INVENTION

In accordance with the present invention, there is provided a stapler, comprising a case assembly including a first handle having a first end provided with a housing and a seat portion spaced from the housing and a second end provided with a first arm, a metallic plate mounted on the seat portion of the first handle and formed with an anvil, a striking plate movably mounted in the housing of the first handle and movable relative to the anvil of the metallic plate, and a second handle pivotally connected with the first handle and having a first end movably mounted in the housing of the first handle and a second end provided with a second arm movable relative to the first arm of the first handle, and a trigger mechanism mounted in the housing of the first handle and including a pivot member having a first end provided with a drive portion detachably attached to the striking plate to move the striking plate outward relative to the anvil of the metallic plate and a second end provided with a driven portion rested on and driven by the first end of the second handle, and a torsion spring biased between the housing of the first handle and the striking plate to provide a restoring force to move the striking plate toward the anvil of the metallic plate.

The primary objective of the present invention is to provide a pliers type stapler.

Another objective of the present invention is to provide a stapler, wherein the striking plate is lowered from its uppermost position to staple the article to be stapled instantaneously so that the striking plate has greater impact stroke and strength so as to staple the article efficiently without incurring deflection, thereby enhancing the stapling effect and quality of the stapler.

A further objective of the present invention is to provide a stapler, wherein the stapler is operated like pliers, so that the user can operate the stapler conveniently, thereby saving the manual work.

A further objective of the present invention is to provide a stapler, wherein the stapler has a simplified construction, thereby decreasing the costs of fabrication.

A further objective of the present invention is to provide a stapler, wherein the second handle is connected with the first handle, the magazine is mounted between the first handle and the second handle, and the push mechanism is mounted on the magazine, so that the stapler is assembled easily and rapidly, thereby facilitating assembly of the stapler.

A further objective of the present invention is to provide a stapler, wherein the hook of the push mechanism is inserted into and detached from the hook hole of the magazine, so that the push mechanism is inserted into and detached from the magazine easily and rapidly, thereby facilitating the user feeding the staples.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a stapler in accordance with the preferred embodiment of the present invention.

FIG. 2 is an exploded perspective view of the stapler as shown in FIG. 1.

FIG. 3 is a plan cross-sectional view of the stapler as shown in FIG. 1.

FIG. 4 is a schematic operational view of the stapler as shown in FIG. 3 in use.

### DETAILED DESCRIPTION OF THE INVENTION

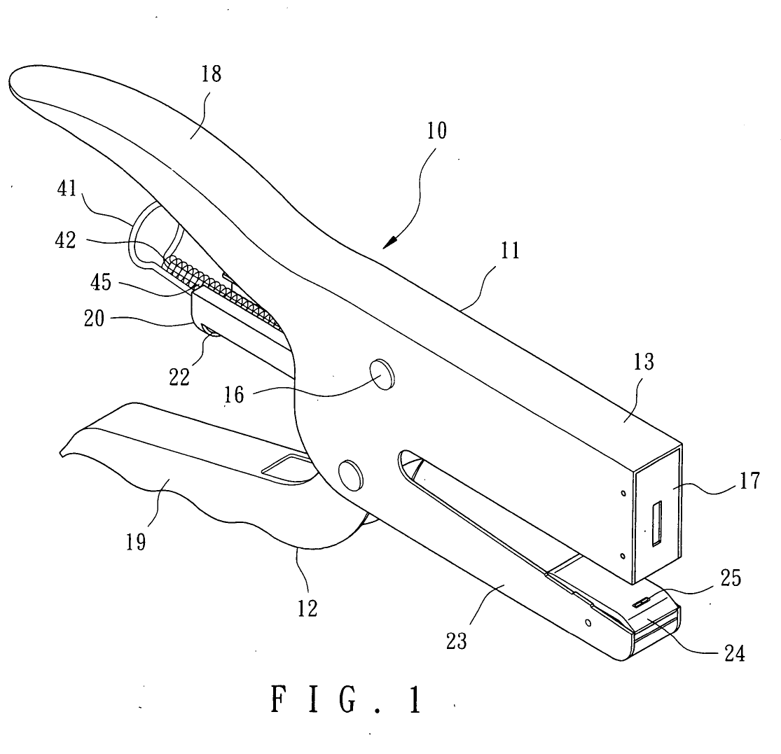

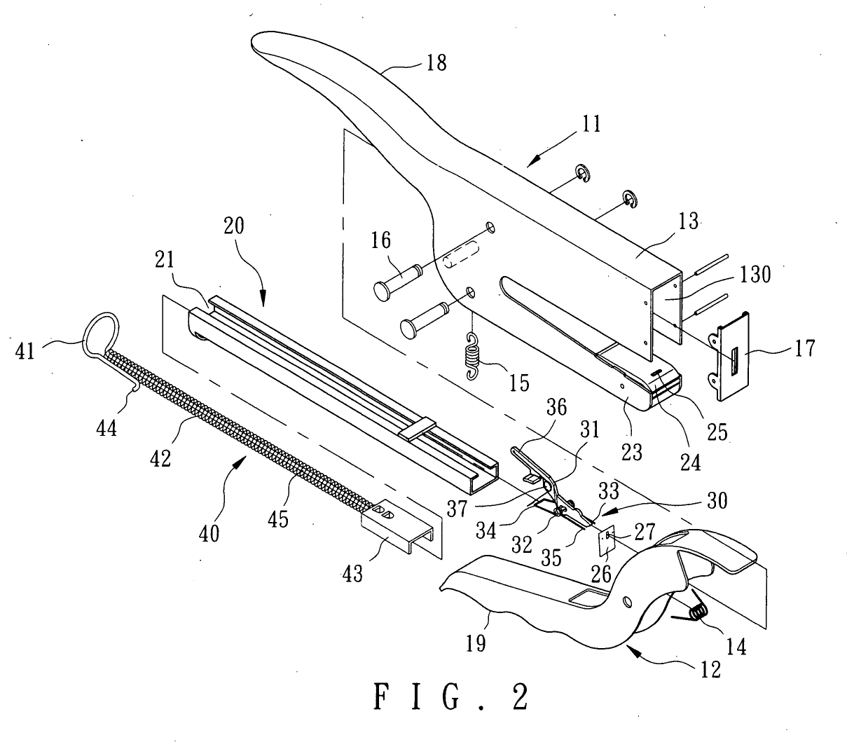

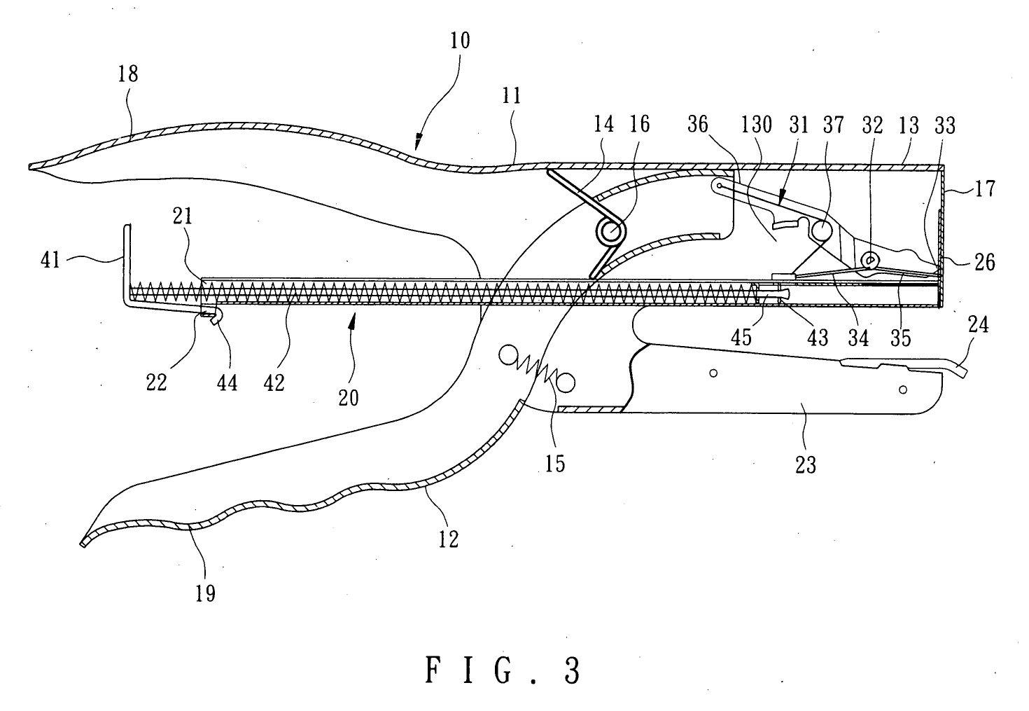

Referring to the drawings and initially to FIGS. 1-3, a pliers type stapler in accordance with the preferred embodiment of the present invention comprises a case assembly 10, a magazine 20, a trigger mechanism 30, and a push mechanism 40.

The case assembly 10 includes a first handle 11 having a bifurcate first end provided with a housing 13 and a seat portion 23 spaced from the housing 13 and a second end provided with a first arm 18, an enclosure 17 mounted on the housing 13 of the first handle 11 to seal the housing 13, a metallic plate 24 mounted on the seat portion 23 of the first handle 11 and formed with an anvil 25, a striking plate 26 movably mounted in the housing 13 of the first handle 11 and movable relative to the anvil 25 of the metallic plate 24, and a second handle 12 pivotally connected with the first handle 11 and having a first end movably mounted in the housing 13 of the first handle 11 and a second end provided with a second arm 19 movable relative to the first arm 18 of the first handle 11. The housing 13 of the first handle 11 is formed with a receiving chamber 130 to receive the trigger mechanism 30. The striking plate 26 is movably rested on the enclosure 17 and has a hook hole 27. The second handle 12 is pivotally connected with the first handle 11 by a pivot shaft 16 which is located at a mediate portion of the first handle 11 and located adjacent to the first end of the second handle 12.

The case assembly 10 further includes a first restoring spring 14 mounted on the pivot shaft 16 and biased between the first handle 11 and the second handle 12 to push the second arm 19 of the second handle 12 outwardly relative to the first arm 18 of the first handle 11, and a second restoring spring 15 biased between the seat portion 23 of the first handle 11 and a mediate portion of the second handle 12 to pull the second arm 19 of the second handle 12 outwardly relative to the first arm 18 of the first handle 11. Thus, the second arm 19 of the second handle 12 and the first arm 18 of the first handle 11 are disposed at an open state normally by the elastic force of the first restoring spring 14 and the second restoring spring 15.

The magazine 20 is mounted between the first handle 11 and the second handle 12 and located at the mediate portions of the first handle 11 and the second handle 12. The magazine 20 has an inside formed with a guide groove 21 containing staples (not shown) therein. The guide groove 21 of the magazine 20 is extended through a whole length of the magazine 20. The magazine 20 has a distal end protruded outward from the first handle 11 and the second handle 12 and formed with a hook hole 22.

The trigger mechanism 30 is mounted in the housing 13 of the first handle 11 and includes a pivot member 31 pivotally mounted on the housing 13 of the first handle 11 and having a first end provided with a drive portion 33 detachably attached to the striking plate 26 to move the striking plate 26 outward relative to the anvil 25 of the metallic plate 24 and a second end provided with a driven portion 36 rested on and driven by the first end of the second handle 12, a torsion spring 32 biased between the housing 13 of the first handle 11 and the striking plate 26 to provide a restoring force to move the striking plate 26 toward the anvil 25 of the metallic plate 24, and a restoring spring 37 biased between the housing 13 of the first handle 11 and the pivot member 31 to provide a restoring force to the pivot member 31. The drive portion 33 of the pivot member 31 is detachably hooked in the hook hole 27 of the striking plate 26. The torsion spring 32 is mounted on the first end of the pivot member 31 and has a first leg 34 rested on the housing 13 of the first handle 11 and a second leg 35 locked to the striking plate 26 to move the striking plate 26. The pivot member 31 has a mediate portion pivotally mounted on the housing 13 of the first handle 11, and the restoring spring 37 is mounted on the mediate portion of the pivot member 31 and has a first end rested on the housing 13 of the first handle 11 and a second end rested on the driven portion 36 of the pivot member 31.

The push mechanism 40 is removably mounted on the magazine 20 to push the staples contained in the magazine 20. The push mechanism 40 includes a support bar 45 secured to the magazine 20, a slide 43 slidably mounted on the support bar 45 and slidable in the guide groove 21 of the magazine 20, and a push spring 42 mounted on the support bar 45 and rested on the slide 43. The support bar 45 of the push mechanism 40 is located in the guide groove 21 of the magazine 20 and has a distal end protruded outward from the guide groove 21 of the magazine 20 and formed with a substantially C-shaped grip portion 41 having a distal end formed with a hook 44 detachably hooked in the hook hole 22 of the magazine 20 so that the support bar 45 of the push mechanism 40 is removably secured to the magazine 20. The push spring 42 is biased between the grip portion 41 of the support bar 45 and the slide 43 to push the slide 43 toward the striking plate 26.

In practice, when the second arm 19 of the second handle 12 and the first arm 18 of the first handle 11 are movable toward each other, the driven portion 36 of the pivot member 31 is pressed by the first end of the second handle 12 to move toward the seat portion 23 of the first handle 11, and the drive portion 33 of the pivot member 31 is driven to move outward relative to the seat portion 23 of the first handle 11 to move the striking plate 26 outward relative to the anvil 25 of the metallic plate 24. At this time, when the striking plate 26 is movable outward relative to the anvil 25 of the metallic plate 24, the torsion spring 32 is distorted to provide a restoring force to move the striking plate 26 toward the anvil 25 of the metallic plate 24 after the drive portion 33 of the pivot member 31 is movable to detach from the striking plate 26.

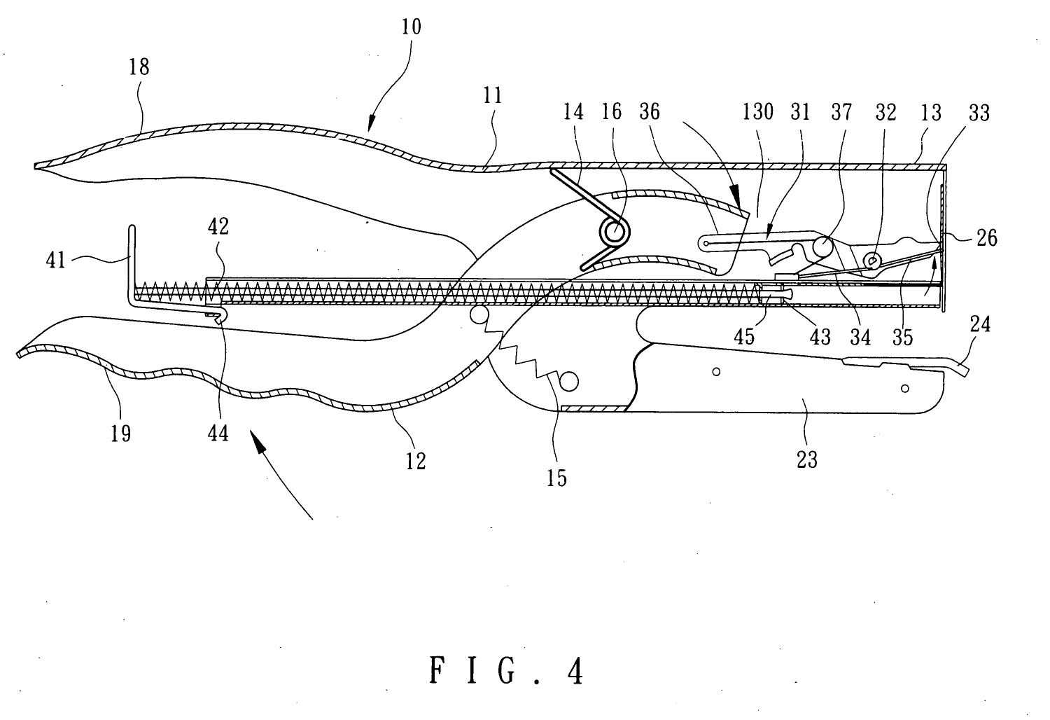

As shown in FIG. 4, when the second arm 19 of the second handle 12 and the first arm 18 of the first handle 11 are pressed and moved toward each other, the driven portion 36 of the pivot member 31 is pressed by the first end of the second handle 12 to move toward the seat portion 23 of the first handle 11, and the drive portion 33 of the pivot member 31 is driven to move outward relative to the seat portion 23 of the first handle 11 so that the striking plate 26 is moved upwardly relative to the anvil 25 of the metallic plate 24.

After the drive portion 33 of the pivot member 31 is lifted to its uppermost position, the drive portion 33 of the pivot member 31 is detached from the hook hole 27 of the striking plate 26 to release the striking plate 26, so that the striking plate 26 is moved toward the anvil 25 of the metallic plate 24 by the restoring force of the torsion spring 32 to strike the staples of the magazine 20, thereby achieving the stapling function.

Accordingly, the striking plate 26 is lowered from its uppermost position to staple the article to be stapled instantaneously so that the striking plate 26 has greater impact stroke and strength so as to staple the article efficiently without incurring deflection, thereby enhancing the stapling effect and quality of the stapler. In addition, the stapler is operated like pliers, so that the user can operate the stapler conveniently, thereby saving the manual work. Further, the stapler has a simplified construction, thereby decreasing the costs of fabrication. Further, the second handle 12 is connected with the first handle 11, the magazine 20 is mounted between the first handle 11 and the second handle 12, and the push mechanism 40 is mounted on the magazine 20, so that the stapler is assembled easily and rapidly, thereby facilitating assembly of the stapler. Further, the hook 44 of the push mechanism 40 is inserted into and detached from the hook hole 22 of the magazine 20, so that the push mechanism 40 is inserted into and detached from the magazine 20 easily and rapidly, thereby facilitating the user feeding the staples.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A stapler, comprising:
a case assembly including a first handle having a first end provided with a housing and a seat portion which is spaced from the housing and having a second end provided with a first arm, a metallic plate mounted on the seat portion of the first handle and formed with an anvil, a striking plate movably mounted in the housing of the first handle and movable relative to the anvil of the metallic plate, the striking plate including a hook hole formed therein, and a second handle pivotally connected with the first handle and having a first end movably mounted in the housing of the first handle and having a second end provided with a second arm movable relative to the first arm of the first handle;
a trigger mechanism mounted in the housing of the first handle and including a pivot member having a first end provided with a drive portion detachably hooked in the hook hole of the striking plate to move the striking plate outward relative to the anvil of the metallic plate and a second end provided with a driven portion rested on and driven by the first end of the second handle, and a torsion spring biased between the housing of the first handle and the striking plate and including a first leg rested on the housing of the first handle and a second leg locked to the striking plate to move the striking plate and to provide a restoring force to move the striking plate toward the anvil of the metallic plate, and
the driven portion of the pivot member being pressed by the first end of the second handle to move toward the seat portion of the first handle, and the drive portion of the pivot member being driven to move outward relative to the seat portion of the first handle to move the striking plate outward relative to the anvil of the metallic plate when the second arm of the second handle and the first arm of the first handle are moved toward each other, and the torsion spring being distorted to provide a restoring force to move the striking plate toward the anvil of the metallic plate when the striking plate is moved outward relative to the anvil of the metallic plate and after the drive portion of the pivot member is detached from the striking plate.

2. The stapler in accordance with claim 1, wherein the first end of the first handle has a bifurcate shape.

3. The stapler in accordance with claim 1, wherein the case assembly further includes an enclosure mounted on the housing of the first handle to seal the housing.

4. The stapler in accordance with claim 3, wherein the striking plate is movably rested on the enclosure.

5. The stapler in accordance with claim 1, wherein the housing of the first handle is formed with a receiving chamber to receive the trigger mechanism.

6. The stapler in accordance with claim 1, wherein the second handle is pivotally connected with the first handle by a pivot shaft which is located at a mediate portion of the first handle and located adjacent to the first end of the second handle.

7. The stapler in accordance with claim 6, wherein the case assembly further includes a first restoring spring mounted on the pivot shaft and biased between the first handle and the second handle to push the second arm of the second handle outwardly relative to the first arm of the first handle, and a second restoring spring biased between the seat portion of the first handle and a mediate portion of the second handle to pull the second arm of the second handle outwardly relative to the first arm of the first handle.

8. The stapler in accordance with claim 7, wherein the second arm of the second handle and the first arm of the first handle are disposed at an open state normally by an elastic force of the first restoring spring and the second restoring spring.

9. The stapler in accordance with claim 1, wherein the pivot member is pivotally mounted on the housing of the first handle.

10. The stapler in accordance with claim 1, wherein the trigger mechanism further includes a restoring spring biased between the housing of the first handle and the pivot member to provide a restoring force to the pivot member.

11. (canceled)

12. The stapler in accordance with claim 1, wherein the torsion spring is mounted on the first end of the pivot member.

13. The stapler in accordance with claim 10, wherein the pivot member has a mediate portion pivotally mounted on the housing of the first handle, and the restoring spring is mounted on the mediate portion of the pivot member and has a first end rested on the housing of the first handle and a second end rested on the driven portion of the pivot member.

14. The stapler in accordance with claim 1, further comprising a magazine mounted between the first handle and the second handle.

15. The stapler in accordance with claim 14, wherein the magazine has an inside formed with a guide groove extended through a whole length of the magazine.

16. The stapler in accordance with claim 14, further comprising a push mechanism removably mounted on the magazine and including a support bar secured to the magazine, a slide slidably mounted on the support bar and slidable in the guide groove of the magazine, and a push spring biased mounted on the support bar and rested on the slide.

17. The stapler in accordance with claim 16, wherein the magazine has a distal end protruded outward from the first handle and the second handle and formed with a hook hole, and the support bar of the push mechanism is located in the guide groove of the magazine and has a distal end protruded outward from the guide groove of the magazine and formed with a substantially C-shaped grip portion having a distal end formed with a hook detachably hooked in the hook hole of the magazine so that the support bar of the push mechanism is removably secured the magazine.

18. The stapler in accordance with claim 16, wherein the push spring is biased between the grip portion of the support bar and the slide to push the slide toward the striking plate.

19-20. (canceled)
